(19) United States
(12) Patent Application Publication
(10) Pub. No.: US 2021/0155188 A1
(43) Pub. Date: May 27, 2021

(54) SAFETY RESTRAINT SYSTEM FOR MOTOR VEHICLES

(71) Applicants: Roman MÁTL, Brno (CZ); Martin HAVLÍK, Znojmo (CZ); RADALI SPOL,. S.R.O., Brno (CZ)

(72) Inventor: Alojz HANULIAK, Brno (CZ)

(21) Appl. No.: 16/614,309

(22) PCT Filed: May 28, 2018
(86) PCT No.: PCT/CZ2018/050027

§ 371 Date: Nov. 15, 2019

(30) Foreign Application Priority Data
May 30, 2017 (CZ) PV 2017-307

(51) Int. Cl. B60R 21/08

(52) U.S. Cl. CPC B60R 21/08; B60R 2021/0048

(57) ABSTRACT

The safety restraint system for motor vehicles, arranged in the roof lining of the vehicle, comprising an elastic wall (1), brackets (2), a gas generator consisting of an inflator, and a control electronics with impact sensors, the essence of which consists in that, that a folded elastic wall (1) is connected under the roof of the vehicle to at least two brackets (2), consisting of a double strip of plastic film and/or elastic textile, when the said brackets (2) consist of a system of tightly into each other inserted extension parts forming a solid bracket (2), whereby an assembly of the folded elastic wall (1) and brackets (2) is arranged in a roof housing (3), and such roof housing (3) is attached under the roof of the vehicle. Both upper edges of the folded elastic wall (1) are firmly attached to the first, upper, solid part (21) of the bracket (2), arranged in the roof housing (3) nearest to the roof lining of the vehicle and firmly connected to this roof housing (3), whereby the double strip of the plastic film and/or elastic textile, forming the elastic wall (1), is on its lower side closed by means of a weld seam and/or a sewn seam to create a closed interior space with the front and rear wall, a bag, in which the brackets (2) are arranged and guided. The brackets (2) are deployed upon activation after an impact of the vehicle on the command of the control electronics with impact sensors by the gas pressure triggered from the gas generator, the inflator; and the mechanical movement of the system of tightly into each other inserted extension parts, forming a solid bracket (2), deploys the elastic wall (1) from a plastic film and/or elastic textile to the maximum, and thus the shape of the elastic wall (1) stretches appropriately and becomes solid. Thus formed elastic wall (1) greatly reduces the forward movement path of the head, and so it reduces the load on the vertebras and prevents contact with a solid obstacle.

### FIELD OF THE INVENTION

The invention relates to the field of safety restraint systems for motor vehicles, in particular passenger cars, for the protection of the driver and the passengers in the event of front and side impacts as a passive safety element.

### BACKGROUND OF THE INVENTION

As an element of the interior passive safety in particular in passenger cars, the airbags has been used, which are passive safety devices, consisting of three main parts—an air bag, a gas generator and control electronics with impact sensors. Basically, it is a bag that inflates in front of the passenger in the event of an accident and decelerates the impact of his body which could otherwise be injured by the steering wheel, dashboard, glass or another part of the car. The airbag itself only slows down the impact, but it is not able to hold the passenger completely, therefore it has to be used in combination with the seat belts. The statistics show that the airbag significantly reduces the risk of death or serious injury to the vehicle crew when the vehicle is hit.

In practice, as an element of passive safety the driver and the front passenger airbags are used to protect against the frontal impact, they are called frontal airbags. Recently, also side airbags arranged on the side of the car, head airbags arranged on the upper side of the windows which protect the passengers' heads in the event of a side impact, knee airbags protecting the driver's knees, the so called front centre airbag protecting the driver in the event of a side impact against the front passenger's body, or other types are often used. The new generation of airbags is able to adapt the inflating of the air bag according to the intensity of the impact, those are the so-called adaptive airbags.

The disadvantage, in particular of the frontal airbags, is the fact that the folded air bag has been arranged in the dashboard structure and so, to a large extent, it determines which elements may be used in the interior and where.

The latest trend in the automotive industry that should replace the conventional pair of airbags for the driver and for the front seat passenger are the so called roof airbags, i.e. the airbags that are placed in the vehicle's roof fining and, when activated, they fill the entire front part of the cabin. They replace both basic frontal airbags. Placing the airbag in the roof lining does not require any significant changes in the design of the roof upholstery and the designers both of the dashboards and the entire vehicle interior do not need to count with the arrangement of the air bag in the dashboard and can design an simpler and a cheaper dashboard design.

One of the examples of a roof airbag solution is, for example, the solution according to the patent KR20030063738, which discloses a roof airbag installed between the roof lining and the vehicle's roof edging, wherein a plurality of connecting lines are created evenly on the airbag roof lining.

Another of the known solutions is the solution according to the patent JP2005067272, which discloses the structure of the vehicle's roof airbag that is directed from the vehicle roof downwards during a vehicle crash.

Also known is the solution of the roof airbag according to the patent DE20200601468 disclosing, in particular, a division element of the airbag that is arranged between the inner surface of the metal roof of the vehicle and the interior roof liner.

The solution of the roof airbag according to the patent DE102004026776 is also known, this patent discloses an airbag covering the entire area between the vehicle roof lining and the passengers arms which is connected to the roof lining between the front and rear struts by means of suitable fastening elements, and which is particularly effective in the event of a roll-over of the vehicle.

Another of the known solutions is the solution according to the patent DE10039800, where the airbag module is located in the area of the vehicle's roof at least over one person in the car. The airbag module is integrated within the roof lining. This and the roof lining make up one assembly unit.

The disadvantage of the roof airbags according to the known solutions is the fact that this is still a conventional airbag design, consisting of an air bag, a gas generator and a control electronics with impact sensors, with all the drawbacks of this solution type of the safety restraint systems for motor vehicles. Just as with other inflatable bags, the shape and above all the configuration of the airbag into the roof lining must be perfectly matched. The airbag has to unfold into its entire three-dimensional space within a fraction of a second at different types of impacts that are directed at different angles, and also differently-sized passengers have to be taken into account.

A necessary condition for proper operation of all airbags in general is the simultaneous wearing seat-belts.

Recently, airbags arranged just in safety bets have also been designed and tested, especially for passengers on the rear seats of the vehicle. The airbags in the safety belts are cylindrical in shape and inflated with compressed cold gas flowing into them through a specially designed clip from a small tank under the seat. As soon as the filling with air starts, the airbag breaks through the textile of the safety belt and extends to the sides around the passenger's body—that all within the same time that a car needs to drive one single meter when running with at a normal motorway speed. Thanks to the application of the compressed air instead of the commonly used chemical reaction in which a certain amount of heat is released as a side effect, the belt does neither burn nor heat after inflating. Compared to the known airbags, it can inflate more slowly and under less pressure because it is not distant from the passenger's body. The inflatable safety belt remains in the inflated condition for several seconds after its activation, then the air gradually discharges through the pores in the material from which the airbag is made.

The so called external airbags have also been developed as passive safety elements that should “bounce” the car from the obstacle in the event of an impact and so replace the missing crumple zones. Special reinforcements for the vehicle doors are being developed, which, in the event of an impact from the side, inflate similarly to airbags.

Further of these external airbags are situated under the floor of the vehicle. When the vehicle detects, that an accident is inevitable, the airbag which is made from a special material and situated under the floor inflates and so it increases friction and helps to slow down the vehicle.

### SUMMARY OF THE INVENTION

The aim of the present invention is to eliminate some drawbacks of the above-mentioned solutions of the restraint systems, the essence of which is the use of an air bag being activated by the impact of the vehicle.

The safety restraint system for motor vehicles, arranged under the roof of a vehicle, comprising an elastic wall, brackets, a gas generator consisting of an inflator, and control electronics with impact sensors, the essence of which is that an assembly of a folded elastic wall is attached under the roof of the vehicle in the car interior by means of a housing, comprising a double strip of plastic film and/or elastic textile, and at least two brackets, when the said brackets consist of a system of into each other tightly inserted extension parts, which after their deployment and filing with gas from the gas generator create a solid bracket, whereby to the first, upper, solid bracket part arranged in the housing nearest to the vehicle roof, having the largest diameter, and firmly connected to the said housing, both upper edges of the folded elastic wall are firmly connected, and the last, lower, extension part of the bracket has a closed bottom, and a double strip of the plastic film and/or elastic textile, creating the elastic wall, is closed on its lower side by means of a welded seam and/or sewn seam to form a closed interior space with a front and rear wall of the said interior space, substantially a narrow bag, in which the brackets are arranged and guided which consist of a system of into each other tightly inserted extension parts. The brackets are deployed upon activation after the impact of the vehicle on the command of the control electronics by the gas pressure coming from the gas generator, the inflator, whereby the mechanical movement of the system of into each other tightly inserted extension parts forms a solid bracket and deploys the wall from the plastic film and/or elastic textile up to the maximum, and thus the shape of the wall stretches and becomes solid appropriately. The extended system of into each other tightly inserted extension parts acts as a solid bracket, stretched by means of gas pressure from the inflator, and forming an elastic wall. Thus formed elastic wall greatly reduces the forward movement path of the head during an impact, thus reducing the load on the vertebras and preventing contact with a solid obstacle which could be the steering wheel or the vehicle's dashboard.

The deployed elastic wall covers all directions of the head movement, especially during a frontal impact into the front part of the vehicle, even beyond its longitudinal axis.

The gas from the inflators in the extended system of into each other tightly inserted extension parts acting as a solid bracket has a much smaller volume than the air volume when using conventional airbags. The gas is not discharged into the interior of the vehicle, but it remains enclosed in the body of the deployed solid bracket formed by the extension parts.

The assembly comprising an elastic wall consisting of a double strip of a plastic film and/or elastic textile, and at least two brackets forming the basis of the safety restraint system for motor vehicles arranged in the roof housing which is firmly attached to or in the structure of the roof lining, may be a part of roof lining without any negative influence on the design of such roof lining.

The safety restraint system for motor vehicles of the present invention can be used also for protection of rear seat passengers, whereby its use significantly reduces the forward movement path in all directions.

### BRIEF DESCRIPTION OF THE FIGURES ON THE DRAWING

The invention will be explained in detail by means of drawings, in which

FIG. 1 shows an axonometric view of three extended brackets attached to the roof housing without an elastic wall,

FIG. 2 shows a schematic frontal view of a fully deployed safety restraint system for motor vehicles with two brackets,

FIG. 3 shows a side view of a fully deployed safety restraint system for motor vehicles,

FIG. 4 shows a frontal view of a folded safety restraint system for motor vehicles mounted in a roof housing,

FIG. 5 shows the state of the vehicle interior with the extended safety restraint system before the forward movement of the driver's head and

FIG. 6 shows the driver's head restrained by the extended safety restraint system.

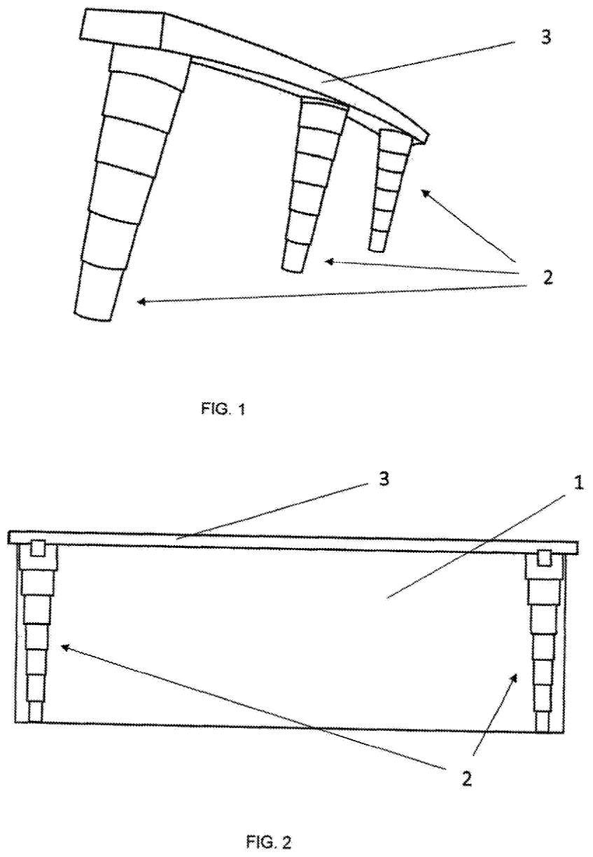

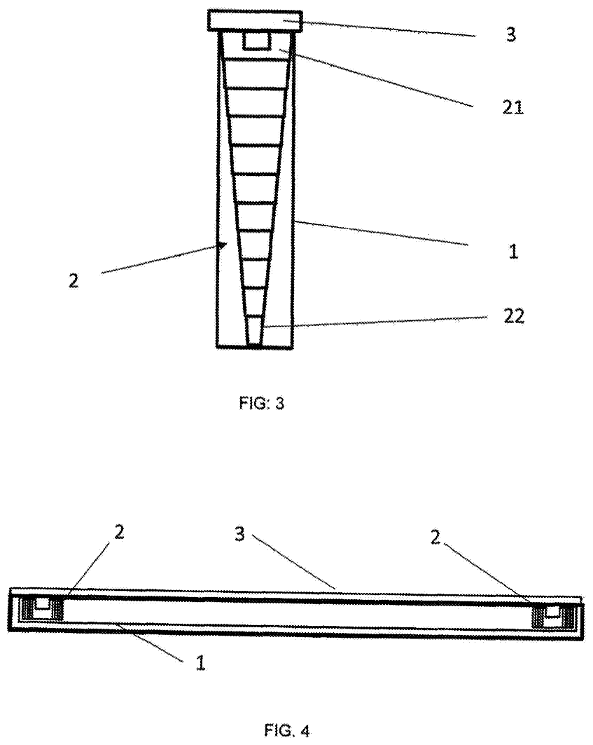

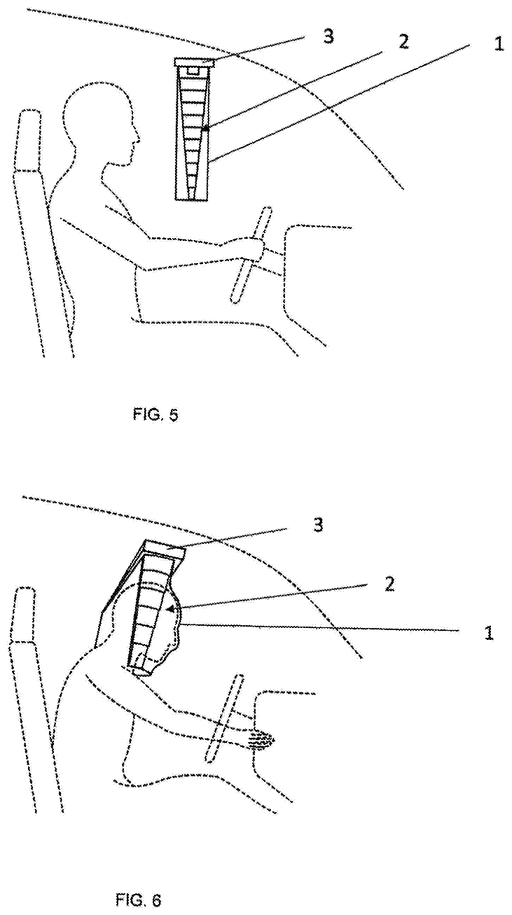

### EXAMPLE OF EMBODIMENTS

Ex. 1) The safety restraint system for motor vehicles, arranged under the vehicle roof, comprising an elastic wall 1 and brackets 2 mounted together in the roof housing 3, a gas generator consisting of an inflator, and control electronics with impact sensors. The roof housing 3, in which a folded elastic wall 1 is attached to the two brackets 2, consisting of a double strip of elastic textile, is connected in the interior under the vehicle roof. The brackets 2 comprise a system of into each other tightly inserted extension parts, forming after the activation under the vehicle impact a solid bracket 2, whereby the first, upper, solid part 21 of the bracket 2, attached to the roof housing 3 nearest to the vehicle roof, is firmly connected to the internal portion of the roof housing 3 and has the largest diameter, and the last, lower, extension part 22 of the bracket 2, has a closed bottom. The double strip of the elastic textile, forming the elastic wall 1 is at its upper side firmly connected to the first, upper, solid part 21 of the bracket 2, arranged nearest to the vehicle roof so that this first solid part 21 of the bracket 2 is arranged inside the double strip of the elastic textile, forming the elastic wall 1, and on its lower side is this double strip closed by means of a welded seam to form a closed interior space with the front and rear wall, thus substantially a narrow bag, in which the brackets 2 are arranged and guided formed by a system of tightly into each other inserted extension parts. When activated after the impact of the vehicle, the brackets 2 are deployed by the gas pressure triggered from the gas generator, the inflator, upon instruction by the control electronics with impact sensors; and the mechanical movement of the system of tightly into each other inserted extension parts forming the solid bracket 2, deploys the wall 1 of elastic textile to the maximum, and thus the shape of the elastic wall 1 stretches appropriately and becomes firm. The extended system of tightly into each other inserted extension parts acts as a solid bracket 2, stretched by the gas pressure from the inflator. So the formed elastic wall 1 greatly reduces the forward movement path of the head, thus reducing the load on the vertebras and preventing contact with a solid obstacle which could be the steering wheel or the dashboard of the vehicle.

Ex. 2) The safety restraint system for motor vehicles, arranged under the vehicle roof, comprising an elastic wall 1 and brackets 2 mounted together in the roof housing 3, a gas generator consisting of an inflator, and control electronics with impact sensors. The roof housing 3, in which a folded elastic wall 1 is attached to the two brackets 2, consisting of a double strip of plastic film, is connected in the interior under the vehicle roof. The brackets 2 comprise a system of tightly into each other inserted extension parts, forming after the activation a solid bracket 2, whereby the first, upper, solid part 21 of the bracket 2, attached to the roof housing nearest to the vehicle roof has the largest diameter, and the last, lower, extension part 22 of the bracket 2, has a closed bottom. The double strip of the plastic film, forming the elastic wall 1 is at its upper side firmly connected to the first, upper, solid part 21 of the bracket 2 arranged nearest under the vehicle roof so that this first solid part 21 of the bracket 2 is arranged inside the double strip of the elastic textile, forming the elastic wall 1, and on its lower side is this double strip closed by means of a sewn seam to form a closed interior space with the front and rear wall, thus substantially a narrow bag, in which the brackets 2 are arranged and guided formed by a system of tightly into each other inserted extension parts. When activated after the impact of the vehicle, the brackets 2 are deployed by the gas pressure triggered from the gas generator, the inflator, upon instruction by the control electronics with impact sensors. The mechanical movement of the system of tightly into each other inserted extension parts forming the solid bracket 2, deploys the elastic wall 1 of elastic textile to the maximum, and thus the shape of the elastic wall 1 stretches appropriately and becomes firm. The extended system of tightly into each other inserted extension parts acts as a solid bracket 2, stretched by the gas pressure from the inflator. Thus formed elastic wall 1 greatly reduces the forward movement path of the head, thereby reducing the load on the vertebras and preventing contact with a solid obstacle which could be the steering wheel or the dashboard of the vehicle.

A similarly embodied safety restraint system for motor vehicles is also used for the protection of passengers sitting on the rear seats. Its use significantly reduces the forward movement path of all passengers sitting on rear seats in all directions.

Ex. 3) The safety restraint system for motor vehicles, arranged under the vehicle roof, comprising an elastic wall 1 and brackets 2 mounted together in the roof housing 3, a gas generator consisting of an inflator, and control electronics with impact sensors. The roof housing 3, in which a folded elastic wall 1 is attached to the three brackets 2, consisting of a double strip of an elastic nanofilm, is connected in the interior under the vehicle roof. The brackets 2 comprise a system of tightly into each other inserted extension parts, after the activation forming a solid bracket 2, whereby the first, upper, solid part 21 of the bracket 2, attached to the roof housing 3 neares under the vehicle roof has the largest diameter, and the last, lower, extension part 22 of the bracket 2, has a closed bottom. The double strip of the elastic nanofilm, forming the elastic wall 1 is at its upper side firmly connected to the first, upper, solid part 21 of the bracket 2, arranged nearest under the vehicle roof so that this first solid part 21 of the bracket 2 is arranged inside the double strip of the elastic nanofilm, forming the elastic wall 1. On its lower side is this double strip of elastic nanofilm closed by means of a sewn seam to form a closed interior space with the front and rear wall, thus substantially a narrow bag, in which the brackets 2 are arranged and guided formed by a system of tightly into each other inserted extension parts. When activated after the impact of the vehicle, the brackets 2 are deployed by the gas pressure triggered from the gas generator, the inflator, upon instruction by the control electronics with impact sensors. The mechanical movement of the system of tightly into each other inserted extension parts forming the solid bracket 2, deploys the elastic wall 1 of elastic nanofilm to the maximum, and thus the shape of the elastic wall 1 stretches appropriately and becomes firm. The extended system of tightly into each other inserted extension parts acts as a solid bracket 2, stretched by the gas pressure from the inflator. Thus formed elastic wall 1 greatly reduces the forward movement path of the head, thereby reducing the load on the vertebras and preventing contact with a solid obstacle formed by the steering wheel or the dashboard of the vehicle.

### INDUSTRIAL APPLICABILITY

The safety restraint system for motor vehicles according to the present invention is usable for all types of vehicles.

1. The safety restraint system for motor vehicles, arranged in the roof lining of a vehicle, comprising an elastic wall (1), brackets (2), a gas generator, consisting of an inflator, and a control electronics with impact sensors, characterised in that the elastic wall (1), formed by a strip of plastic film and/or elastic textile, is connected at least to two brackets (2), formed by a system of tightly into each other inserted extension parts, producing a solid bracket (2) after the activation during an impact of the vehicle, where the assembly of the folded elastic wall (1), consisting of a double strip of a plastic film and/or elastic textile, and the brackets (2) is together arranged in the roof housing (3), attached under the roof of the vehicle in the area in front of the driver's head and the front seat passenger's head and/or in the area in front of the heads of passengers on other seats.

2. The safety restraint system for motor vehicles according to claim 1, characterised in that the first, upper, solid part (21) of the bracket (2) has the largest diameter, is arranged in the roof housing (3) immediately under the roof lining of the vehicle, and it is firmly attached to the roof housing (3), and the last, lower, extension part (22) of the bracket (2) has a closed bottom, where both upper edges of the folded elastic wall (1) are firmly attached to the first, upper, solid part (21) of the bracket (2), arranged in the roof housing (3) nearest to the roof lining of the vehicle and it is firmly attached to this roof housing (3), whereby the double strip of the plastic film and/or elastic textile, forming an elastic wall (1) is on its lower side closed by means of a welded seam and/or sewn seam to create a closed interior space with the front and rear wall, a bag or a pillow, in which the brackets (2) are arranged and guided, formed by a system of tightly into each other inserted extension parts.

3. The safety restraint system for motor vehicles according to claim 1 and 2, characterized in that the brackets (2) are, when the restraint system is activated after an impact of the vehicle upon instruction by the control electronics with impact sensors, deployed by means of the gas pressure from the gas generator, the inflator, whereby the mechanical movement of the system of tightly into each other inserted extension parts forming so a solid bracket, (2) deploys the elastic wall (1) from plastic film and/or elastic textile, firmly connected by means of upper edges to the first, upper, solid part (21) of the bracket, to the maximum, whereby the shape of the elastic wall (1) stretches appropriately and becomes firm.

4. The safety restraint system for motor vehicles according to claims 1 to 3, characterised in that the elastic wall (1) consists of a double strip of an elastic nanofilm.

5. The safety restraint system for motor vehicles according to claims 1 to 4, characterised in that the gas from the gas generator, the inflator, remains closed only in the body of the deployed solid bracket (2), consisting of extension parts.
